(19) United States
(12) Patent Application Publication
(10) Pub. No.: US 2013/0256936 A1
(43) Pub. Date: Oct. 3, 2013

(54) METHOD FOR MANUFACTURING VENTILATION CLOTH HAVING SUEDE EFFECTS

(71) Applicant: Su-Fang OU, Taichung City (TW)

(72) Inventor: Su-Fang OU, Taichung City (TW)

(21) Appl. No.: 13/433,610

(22) Filed: Mar. 29, 2012

(51) Int. Cl. B29C 51/10

(52) U.S. Cl. 264/101

(57) ABSTRACT

A method for manufacturing ventilation cloth having suede effects temporarily combines a film layer to an upper surface of a metal net via a temporary combining device. A plurality of apertures of a suction mold allow the film layer above meshes of the metal net to be strongly sucked, thereby contributing to rough edges and breaking holes. The rough edges go through the meshes and extend to a lower surface of the metal net. Subsequently, the suede effects are achieved along with the benefit of ventilation and prevention of peep.

### BACKGROUND OF THE INVENTION

1. Field of the Invention

The present invention relates to a method for manufacturing ventilation cloth having suede effects, especially to a metal net that is formed into nap cloth after a film layer is proceeded to vacuum forming process so as to provide ventilation and prevention of peep.

2. Description of the Related Art

Nap cloth is commonly seen in the market. In fact, the nap cloth provides unsatisfactory ventilation; namely, it is difficult to expel air, so odors are incurred inside the nap cloth. Differently, a ventilation net is commonly made by fabric, plastic, or metal wire. Although such ventilation net has superior aeration, the visual effect is plain since it is impossible to cooperate with the nap cloth. Especially in the shoe materials or the building materials, it is rare to see the nap cloth cooperating with the ventilation net.

### SUMMARY OF THE INVENTION

It is therefore the purpose of this invention to provide a method for manufacturing ventilation cloth having suede effects. Characterized in that, a film layer is temporarily stuck on an upper surface of a metal net via a temporary combining device, the metal net and the film layer that are temporarily combined are placed on a tray of a suction mold, a plurality of apertures are defined on the tray, a heater is disposed above the film layer, the apertures are aimed at meshes of the metal net for proceeding with a vacuum forming process, the film layer above the meshes is strongly sucked so as to cause rough edges and breaking holes, and the rough edges go through the meshes and extend under the metal net. The film layer is extruded and the film layer is temporarily stuck on the upper surface via a heating roller. The combined film layer and the metal net are placed on the tray for a heater to melt and soften the film layer. The apertures are aimed at the meshes of the metal net for the film layer to proceed with the vacuum forming process. When the rough edges and breaking holes are caused, the metal net provides the suede effects with ventilation.

Another purpose of the present invention is to provide a method for manufacturing ventilation cloth having suede effects. Characterized in that, when the film layer is formed by plastically laminating, the film layer is directly and temporarily stuck on the upper surface of the metal net without using the temporary combining device. The combined metal net and the film layer are placed on the tray for the heater to melt and soften the film layer, a plurality of apertures are aimed at meshes of the metal net for proceeding with the vacuum forming process, and the film layer is strongly sucked so as to cause rough edges and breaking holes, and thereby suede effects are provided on the lower surface of the metal net. Accordingly, the cloth preferably shields off light.

A further purpose of the present invention is to provide a method for manufacturing ventilation cloth having suede effects. Characterized in that, at least one pattern is printed on the film layer in advance. The film layer with uneven thickness makes the pattern produce unsatisfactory breaking holes after the vacuum forming process so as to present a solid effect on the pattern.

A further purpose of the present invention is to provide a method for manufacturing ventilation cloth having suede effects. Characterized in that, the metal net is pressed for contributing to a solid pattern in advance. After the vacuum forming process, the film layer is stuck on the upper surface of the metal net, the rough edges extend to the lower surface of the metal net, and a solid effect on the pattern is presented.

### BRIEF DESCRIPTION OF THE DRAWINGS

FIG. 1 is an exploded view of the present invention;

FIG. 2 is a schematic view showing a film layer that is temporarily combined;

FIG. 2-A is an enlarged view showing the film layer and a metal net being temporarily combined;

FIG. 3 is a schematic view showing the present invention being placed in a suction mold;

FIG. 4 is a schematic view showing the present invention in heating and vacuum forming process;

FIG. 5 is perspective view of a first preferred embodiment of the present invention;

FIG. 5-A is a back view of the first preferred embodiment of the present invention;

FIG. 6 is an exploded view of a second preferred embodiment of the present invention; and

FIG. 7 is a perspective view showing the second preferred embodiment of the present invention.

### DETAILED DESCRIPTION OF THE PREFERRED EMBODIMENTS

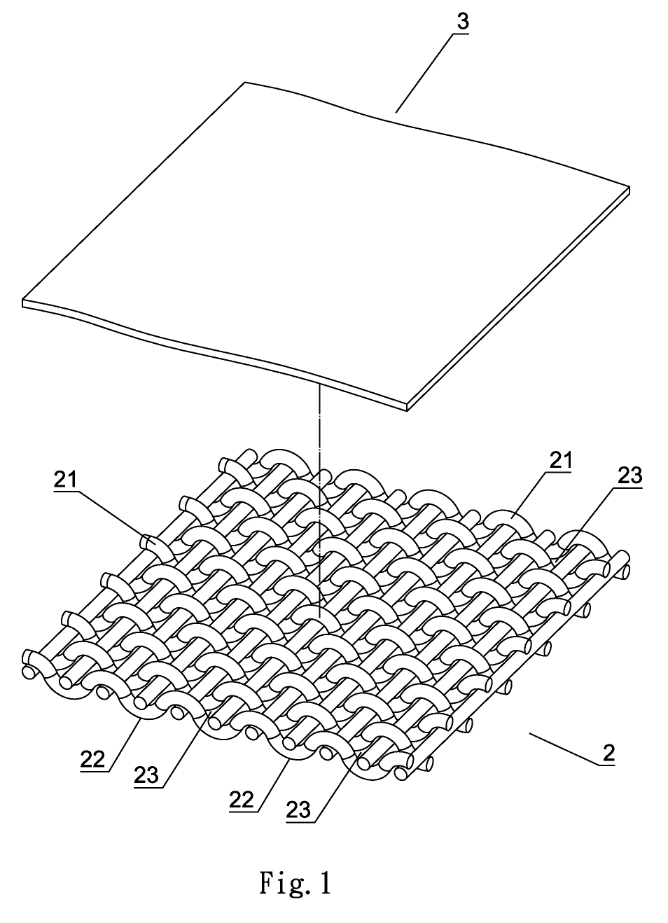

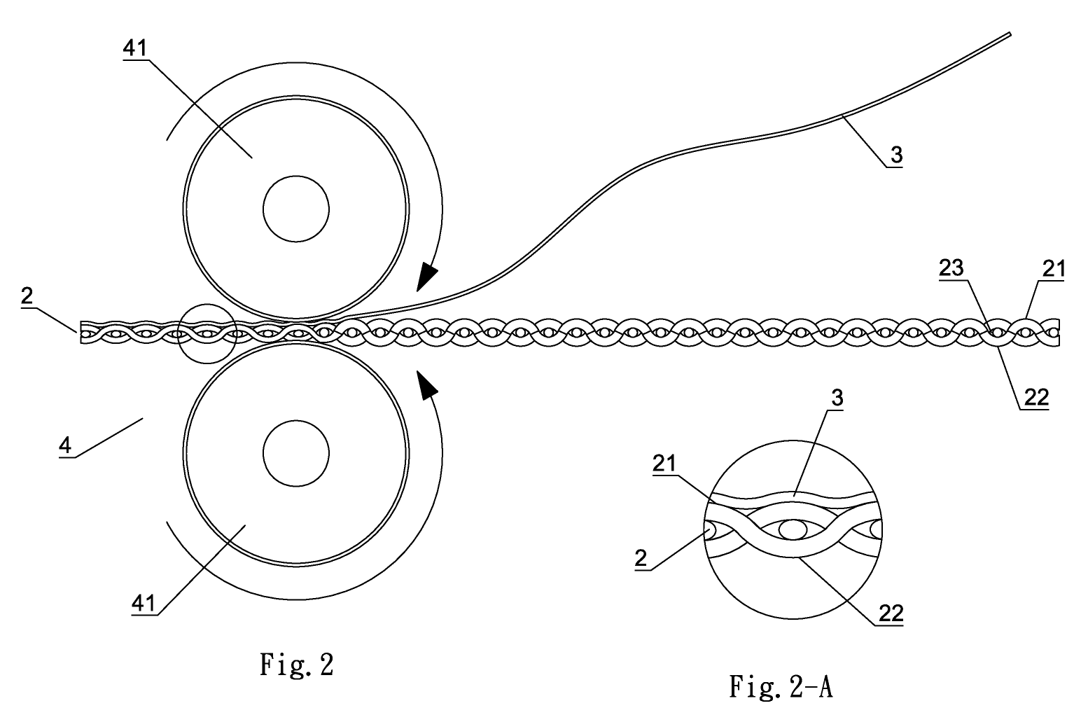

FIG. 1 to FIG. 4, and FIG. 2-A show an upper surface 21 of a metal net 2 being covered by a film layer 3. The film layer 3 is formed into a lamination by extruding or plastically laminating Thermoplastic Polyurethanes or other Thermoplastic Resin. The film layer 3 is temporarily combined with the upper surface 21 of the metal net 2 via a temporary combining device 4. The temporary combining device 4 adopts a heating roller, a high frequency apparatus, or an ultrasonic apparatus. The metal net 2 and the film layer 3 that are temporarily combined are placed on a tray 51 of a suction mold 5, a plurality of apertures 511 are defined on the tray 51, a heater 52 is disposed above the film layer 3 for melting and softening the film layer 3, the apertures 511 are aimed at meshes 23 of the metal net 2 for proceeding with a vacuum forming process from a bottom to a top of the film layer 3, the film layer 3 above the meshes 23 is strongly sucked so as to cause rough edges 31 and breaking holes 32, the rough edges 31 go through the meshes 23 and extend to a lower surface 22 of the metal net 2, thereby accomplishing a product of nap cloth with suede effects which attains the benefit of ventilation.

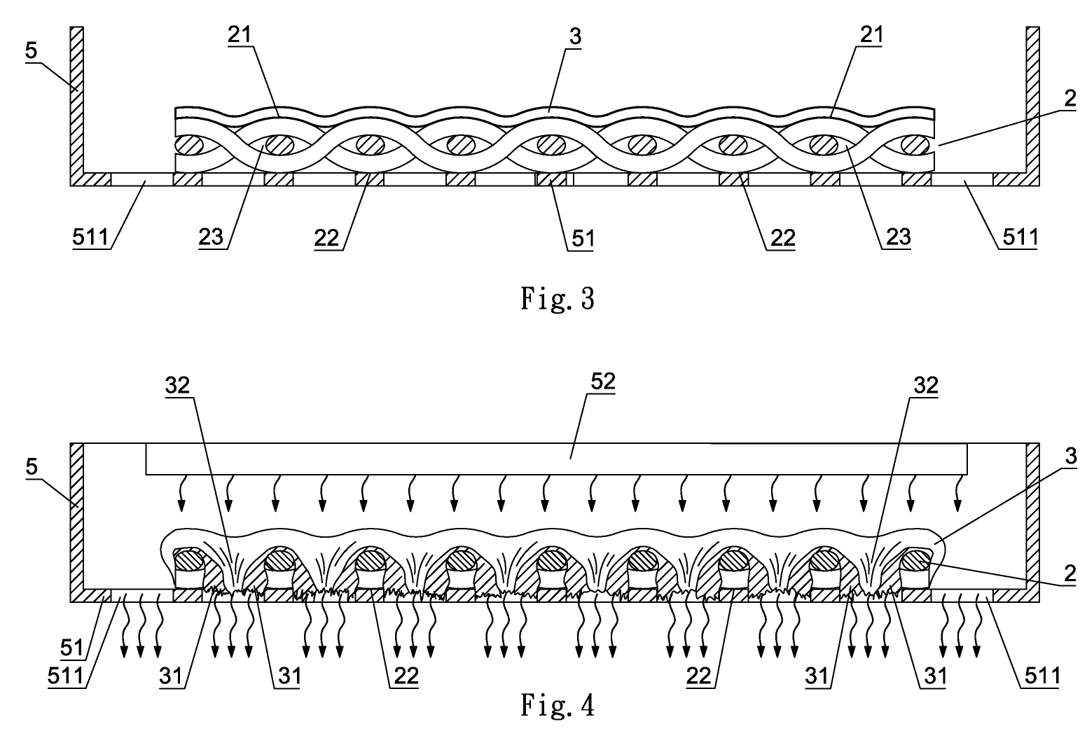

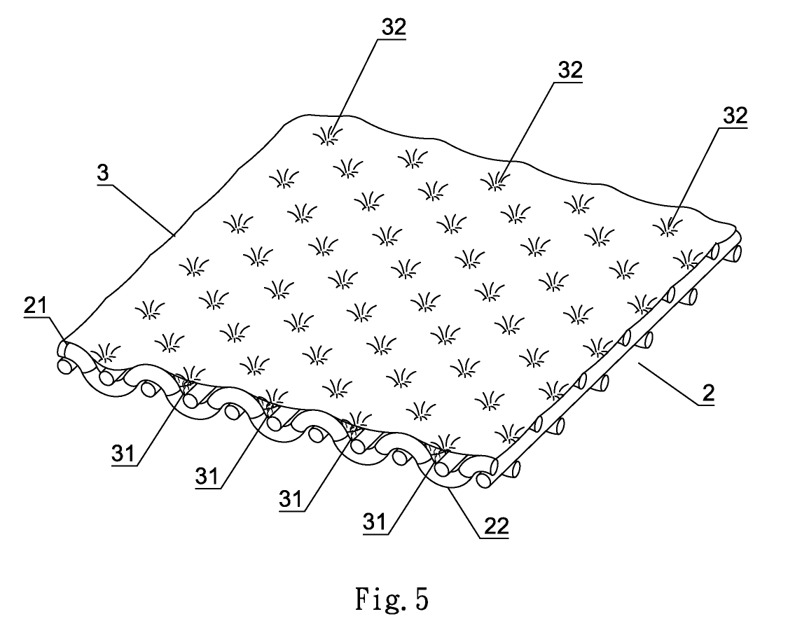

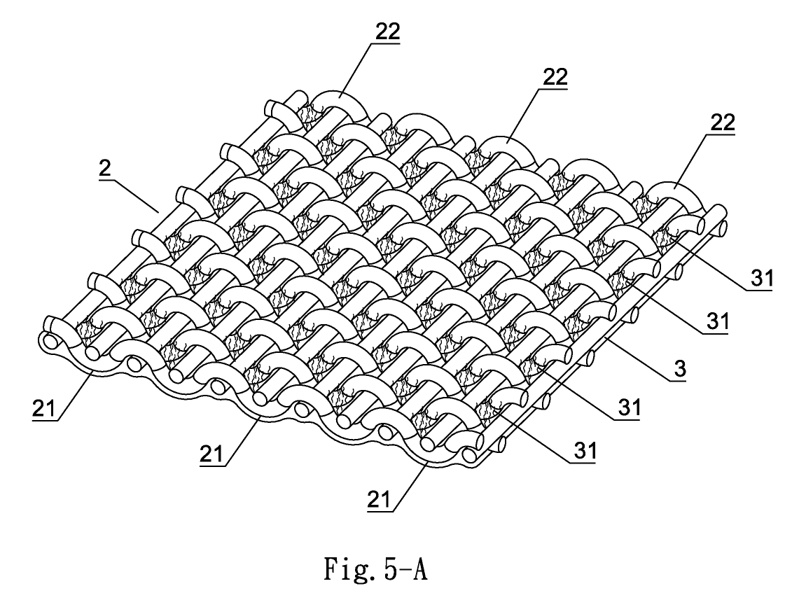

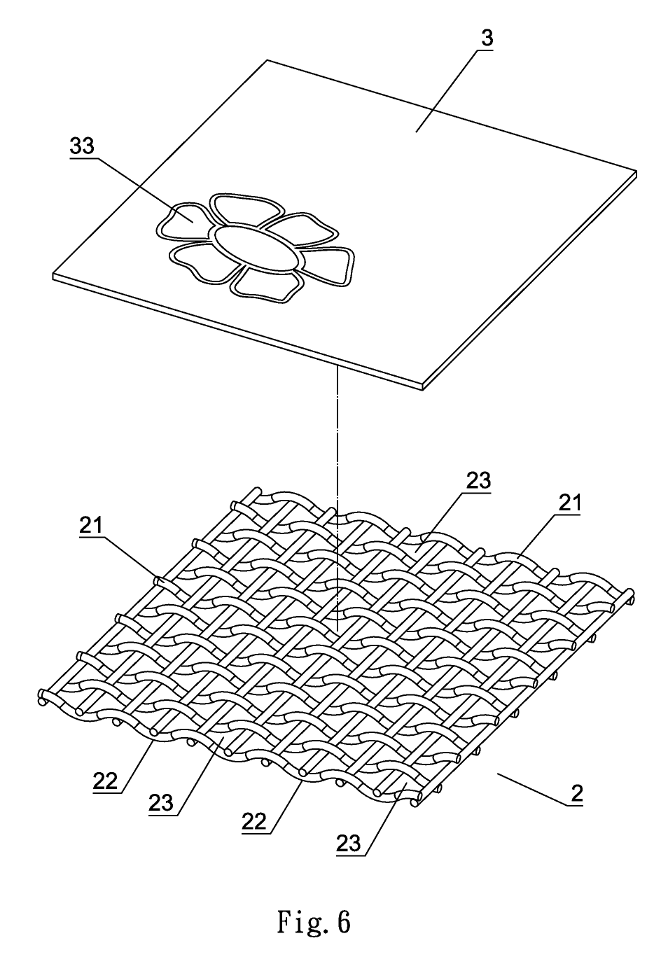

FIGS. 1 to 4 show a first preferred embodiment of the present invention. The film layer 3 is extruded (as shown in FIG. 1) through a heating roller 41 so as to temporarily combine with the upper surface 21 of the metal net 2 (as shown in FIG. 2). The metal net 2 and the film layer 3 that are temporarily combined are placed on the tray 51 (as shown in FIG. 3). The heater 52 is disposed above the film layer 3 for melting and softening the film layer 3. The apertures 511 are aimed at the meshes 23 for the film layer 3 to proceed with the vacuum forming process. The film layer 3 is strongly sucked (as shown in FIG. 4) so as to cause the rough edges 31 and the breaking holes 32 for contributing to the nap cloth (as shown in FIGS. 5 and 6). Wherein, since the lower surface 22 of the metal net 2 is provided with the nap, the cloth preferably shields off light. Moreover, the cloth offers ventilation and prevention of peep.

Further, when the film layer 3 is formed by plastically laminating, the film layer 3 could be directly and temporarily stuck on the upper surface 21 of the metal net 2 without using the temporary combining device 4. The metal net 2 and the film layer 3 that are temporarily combined are placed on the tray 51, the heater 52 is disposed above the film layer 3 for melting and softening the film layer 3, and the apertures 511 are aimed at the meshes 23 for the film layer 3 to proceed with the vacuum forming process. Accordingly, the film layer 3 is strongly sucked so as to cause the rough edges 31 and the breaking holes 32. Wherein, the same nap and the same function are achieved as precedent.

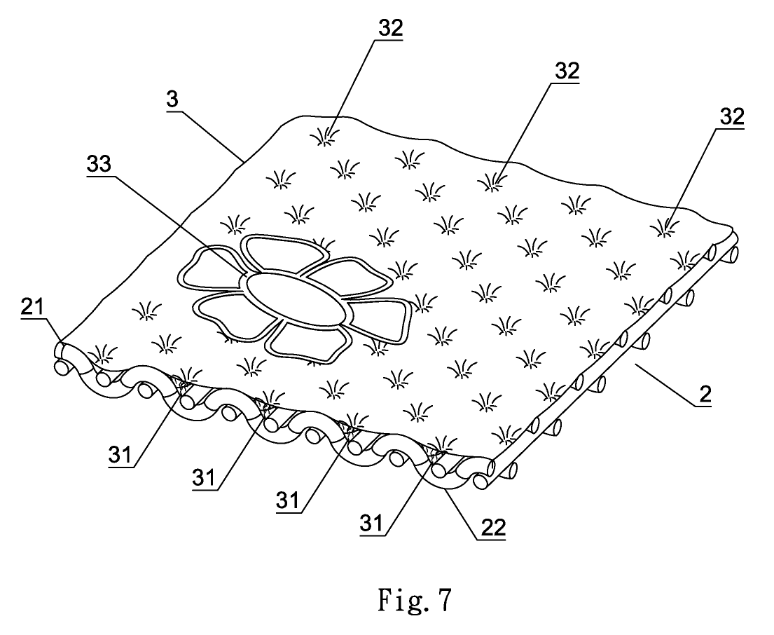

FIGS. 6 to 7 show a second preferred embodiment of the present invention. After the film layer 3 proceeds to extrusion, at least one pattern 33 (as shown in FIG. 6) is printed on the film layer 3. The film layer 3 with uneven thickness (where the pattern 33 is placed is especially thicker) makes the pattern 33 (as shown in FIG. 7) produce unsatisfactory breaking holes after the vacuum forming process so as to present an obvious solid effect on the pattern 33.

FIGS. 6 to 7 also show a third preferred embodiment of the present invention. A metal net 2 is flexible but stiff. The metal net 2 is pressed for contributing to a solid pattern in advance. After the vacuum forming process, the film layer 3 is stuck on the upper surface 21 of the metal net 2, the rough edges 31 extend to the lower surface 22 of the metal net 2, and an obvious solid effect of the pattern is presented.

A size of the meshes 23 of the metal net 2 is suited for the rough edges 31 of the film layer 3 that is proceeded with the vacuum forming process, so that the rough edges 31 go through the meshes 23 and extend toward a lower part of the metal net 2 for achieving the suede effects on the lower surface 22.

While the present invention has been described with regard to particular embodiments, it is recognized that further variations, alternatives and modifications may be apparent to any person skilled in the art and be devised without departing from the scope of the present invention and the inventive concept embodied therein.

I claim:

1. A method for manufacturing ventilation cloth having suede effects, characterized in that, a film layer is temporarily stuck on an upper surface of a metal net via a temporary combining device, said metal net and said film layer that are temporarily combined are placed on a tray of a suction mold, a plurality of apertures are defined on said tray, a heater is disposed above said film layer for melting and softening said film layer, said apertures are aimed at meshes of said metal net for proceeding with a vacuum forming process from a bottom to a top of said film layer, said film layer above said meshes is strongly sucked so as to cause rough edges and breaking holes, said rough edges go through said meshes and extend to a lower surface of said metal net, thereby accomplishing a product of nap cloth with suede effects which attains the benefit of ventilation and prevention of peep.

2. The method as claimed in claim 1, wherein, said film layer is formed into a lamination by extruding or plastically laminating Thermoplastic Polyurethanes or other Thermoplastic Resin.

3. The method as claimed in claim 2, wherein, when said film layer is formed by plastically laminating, said film layer is directly and temporarily stuck on said upper surface of said metal net without using said temporary combining device.

4. The method as claimed in claim 1, wherein, said temporary combining device adopts a heating roller, a high frequency apparatus, or an ultrasonic apparatus.

5. The method as claimed in claim 1, wherein, a size of said meshes is suited for allowing said rough edges to go through said meshes and extend to said lower surface of said metal net for achieving said suede effects.

6. The method as claimed in claim 1, wherein, at least one pattern is printed on said film layer in advance, and said film layer with uneven thickness makes said pattern produce unsatisfactory breaking holes after said vacuum forming process so as to present a solid effect on said pattern.

7. The method as claimed in claim 1, wherein, said metal net is pressed for contributing to a solid pattern in advance; after said vacuum forming process, said film layer is stuck on said upper surface of said metal net, said rough edges extend to said lower surface of said metal net, and a solid effect of said pattern is presented.
